(19) United States
(12) Patent Application Publication
(10) Pub. No.: US 2024/0264066 A1
(43) Pub. Date: Aug. 8, 2024

(54) POLYDISPERSED PARTICLE CHALLENGE SAMPLE VOLUME CALIBRATION OF OPTICAL PARTICLE COUNTERS

(71) Applicant: PARTICLE MEASURING SYSTEMS, INC., Boulder, CO (US)

(72) Inventor: Brian A. KNOLLENBERG, Boulder, CO (US)

(73) Assignee: PARTICLE MEASURING SYSTEMS, INC., Boulder, CO (US)

(21) Appl. No.: 18/432,267

(22) Filed: Feb. 5, 2024

Related U.S. Application Data
(60) Provisional application No. 63/483,576, filed on Feb. 7, 2023.
(60) Provisional application No. 63/606,397, filed on Dec. 5, 2023.

(51) Int. Cl. G01N 15/10; G01N 15/14; G01N 15/1434

(52) U.S. Cl. CPC G01N 15/1012; G01N 15/1434; G01N 2015/1014; G01N 2015/1486

(57) ABSTRACT

A method of calibrating an optical particle counter may include performing first and second calibration procedures. The first calibration procedure may include performing sensitivity calibration and/or channel size calibration of the optical particle counter under calibration using a monodispersed particle standard. The second calibration procedure may include sample volume calibration. The sample volume calibration may include: flowing a polydispersed particle calibration sample dispersed in a fluid through the optical particle counter under calibration to produce a first signal output; flowing the polydispersed particle calibration sample dispersed in the fluid through a reference optical particle counter to produce a reference signal output; comparing the first signal output with the reference signal output; and adjusting, in response to the comparing, an effective sample volume parameter stored in a computer readable memory of the optical particle counter under calibration.

### CROSS-REFERENCE TO RELATED APPLICATIONS

This application claims the benefit of priority to U.S. Provisional Patent Application No. 63/483,576, filed Feb. 7, 2023, and U.S. Provisional Patent Application No. 63/606,397, filed Dec. 5, 2023, each of which is hereby incorporated by reference in its entirety.

### BACKGROUND OF INVENTION

Conventionally, optical particle counters are calibrated using monodispersed or controlled distribution challenge particles. These particles could be size and or count standards of a consistent refractive index material and are used to accurately determine size channel relationships within the instrument or confirm acceptable sample volume based on design parameters. In practice, these particles are run in relatively high concentrations to maximize the signal to noise relative to determination of particle size. Sample volume confirmation is typically made via reference instrument comparisons with monodispersed particles or count standard particle solutions. In both cases, comparisons are typically made with a large quantity of particles to maximize measurement statistical significance. This is almost always performed at a size range the unit under test or reference instrument can fully resolve for improved accuracy. However, when either the reference particle counter or unit under test are unable to fully resolve the distribution of the sample volume challenge particle, results can be quite variable. To compensate for this, particle counter manufacturers typically move to larger sized particles moving away from the lower sensitivity limit of the unit under test to gain visibility to the full monodispersed particle distribution.

While these calibration methods have been in use for 50 years or more, the resultant sample volume determination accuracy can be quite variable since it does not represent the performance of the particle counter at its lowest sensitivity limit. Small differences in counting efficiency between particles of different sizes are magnified by the increased number of particles at the lower detection limits vs. a larger particle the instrument may be able to fully resolve. In real-world use, monitoring particle contamination in naturally occurring polydispersed particle distributions in clean fluids, this sample volume error results in reported particle concentration variability between particle counters.

Accordingly, it can be seen that improved methods are needed for calibration of optical particle counters.

### SUMMARY OF THE INVENTION

The methods used herein may employ naturally occurring polydispersed particle challenges, validations or diagnostics to characterize and adjust the sensitivity or sample volume of a particle counter during manufacture or service. The optical particle counter units under test are compared against reference instruments. Leveraging the highest sensitivity channels and higher concentrations of the smaller particles provides a more real-world reference against which to determine real sample volumes. Field-testing has demonstrated a significant improvement in unit-to-unit matching and supports establishment of tighter control specifications for improved productivity and manufacturing process quality or product yields.

In one embodiment, a method of calibrating a first optical particle counter comprises performing first and second calibration procedures on a first optical particle counter. The first optical particle counter may be a device under calibration. The first calibration procedure may comprise performing sensitivity calibration of the first optical particle counter; and/or channel size calibration of the first optical particle counter using a monodispersed particle standard and/or a pseudo monodispersed particle standard. The second calibration procedure may comprise sample volume calibration of the first optical particle counter. The sample volume calibration may comprise: flowing a polydispersed particle calibration sample dispersed in a fluid through the first optical particle counter to produce a first signal output; flowing the polydispersed particle calibration sample dispersed in the fluid through a second optical particle counter to produce a reference signal output, the second optical particle counter being a reference device; comparing the first signal output with the reference signal output; and adjusting, in response to the comparing, an effective sample volume parameter stored in a computer readable memory of the first optical particle counter.

In one embodiment, the second calibration procedure utilizes a natural polydispersed particle calibration sample. In one embodiment, the second calibration procedure standardizes a sensitivity, counting efficiency and/or sample volume of the first particle counter relative to the reference optical particle counter.

In one embodiment, the signal output of the first optical particle counter has a plurality of signal channels, a first signal channel being correlated to particles corresponding to a lower size detection limit of the first optical particle counter, and wherein the polydispersed particle calibration sample has a higher concentration of particles correlated to the first signal channel than a concentration of particles correlated to other channels of the plurality of signal channels.

In one embodiment, the first calibration procedure comprises flowing a monodispersed particle standard and/or a pseudo monodispersed particle standard dispersed in a fluid through the first optical particle counter. In one embodiment, the monodispersed particle standard is a quantified particle standard.

In one embodiment, the first calibration procedure comprises: flowing the monodispersed particle standard and/or the pseudo monodispersed particle standard through the second optical particle counter or a supplemental reference optical particle counter; and comparing a signal output from the first optical particle counter with a signal output from the second optical particle counter or the supplemental reference optical particle counter. In one embodiment, the average size of particles in the monodisperse particle calibration sample corresponds to a signal channel of the first optical particle counter that is not the first channel.

In one embodiment, the first optical particle counter comprises an optical light source providing a focused beam light on a particle interrogation region, and one or more photodetectors to detect scattered light; and wherein the effective sample volume parameter corresponds to a volume of fluid per unit of time exposed to focused beam conditions and/or detection conditions to be analyzed by the first optical particle counter for the measurement of particles. In one embodiment, the effective sample volume is from 0.01%-90% of the volume per unit time of fluid passed through the first optical particle counter.

In one embodiment, the effective sample volume parameter is a first effective sample volume parameter, the first effective sample volume parameter corresponding to the first signal channel, the method further comprising: determining a second effective sample volume parameter, the second effective sample volume parameter corresponding to a second signal channel of the plurality of signal channels.

In one embodiment, the method comprises calculating, via the effective sample volume parameter, an effective sampling volume of fluid analyzed per unit time of the first optical particle counter. In one embodiment, the method comprises calculating, via the effective sample volume parameter, a number of particles detected per volume of fluid analyzed per unit time of the first optical particle counter.

In one embodiment, the second optical particle counter has a sensitivity equal to or greater than the first optical particle counter. In one embodiment, the polydispersed particle calibration sample is a natural particle sample or an at least partially artificially generated particle sample simulating a natural particle sample. In one embodiment, the polydispersed particle calibration sample is characterized by a natural or pseudo natural polydispersed size distribution.

In one embodiment, the polydispersed particle calibration has a polydispersed size distribution characterized by progressively more particles per unit volume of fluid at smaller sizes for particles having effective diameters greater than or equal to a particle size threshold. In one embodiment, the polydispersed particle calibration has a polydispersed size distribution characterized by particle concentrations inversely proportional to particle effective diameters for particles having effective diameters greater than or equal to a particle size threshold. In one embodiment, the threshold is. 1 nm or optionally 0.02 microns.

In one embodiment, the polydispersed particle calibration sample has a polydispersed particle size distribution at least partially characterized by a log-normal distribution, Gaussian distribution, Lorentzian distribution, multimodal distribution or any combination of these.

In one embodiment, wherein the polydispersed particle calibration sample is characterized by a polydispersed particle size distribution that corresponds to the natural particle size distribution of a target class of analyte particles. In one embodiment, the polydispersed particle calibration sample has an artificial polydispersed particle size distribution that mimics a natural distribution.

In one embodiment, the concentration of particles in the polydispersed particle sample having effective diameters greater than or equal to a particle size threshold (e.g., greater than or equal to 0.02 microns) is proportional to 1/d^{x}, where x is selected from the range of 1.4 to 5. In one embodiment, x is 2.1, 3.0, 4.0, or 5.0. In one embodiment, x is 2.1 or greater, 3.0 or greater, or 4.0 or greater.

In one embodiment, the monodisperse particle calibration sample has a monodispersed particle size distribution characterized by an average particle size selected from the range of 0.002 to 100 microns and a standard deviation selected from the range of 0.1 to 50%.

In one embodiment, the polydispersed particle calibration sample comprises a plurality of particles having a polydispersed size distribution, wherein an average effective particle diameter of the plurality of particles is smaller than a lower detection limit of the first optical particle counter. In one embodiment, the first optical particle counter has a particle size detection limit equal to or greater than 50 nm, 40 nm, 30 nm, 20 nm, 10 nm, 5 nm or 2 nm.

In one embodiment, the first optical particle counter has an effective sampling volume of fluid analyzed per unit time selected from the range of 0.01 ml/min to 100 ml/min.

In one embodiment, the particle standard of the first calibration procedure has a monodispersed particle distribution. In one embodiment, the first optical particle counter has a lower particle size detection threshold, and wherein the monodispersed particle distribution of the particle standard of the first calibration procedure has a peak at a particle size that is at or above the lower particle size detection threshold.

In one embodiment, the particle standard of the first calibration procedure has a pseudo monodispersed particle distribution.

In one embodiment, the particle standard of the second calibration procedure is a natural polydispersed particle standard. In one embodiment, the particle standard of the second calibration procedure is a pseudo natural polydispersed particle standard.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1: Image of Monodispersed vs. Poly-dispersed Particle Distribution.

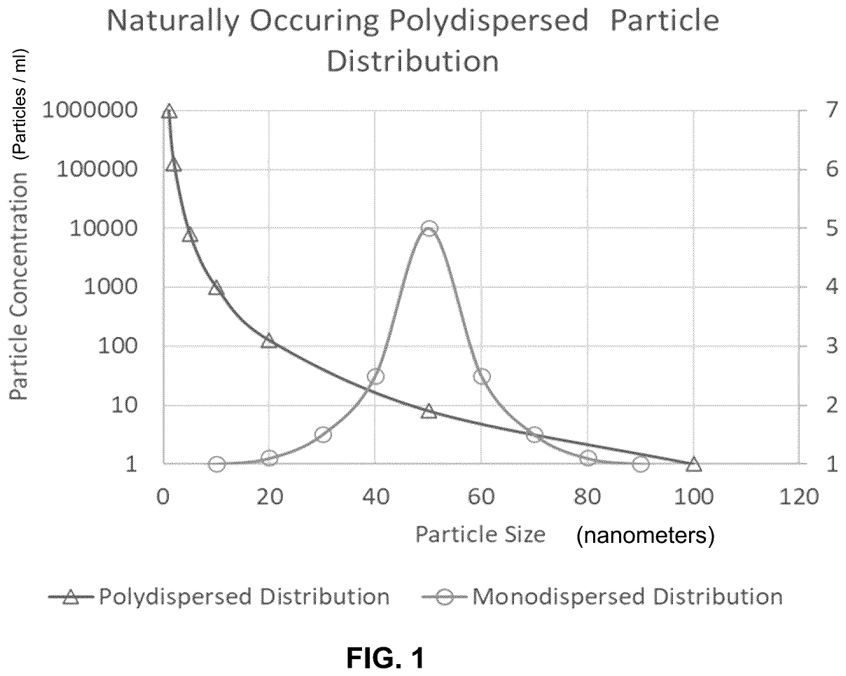

FIG. 2: Examples of naturally occurring polydispersed particle concentration distributions.

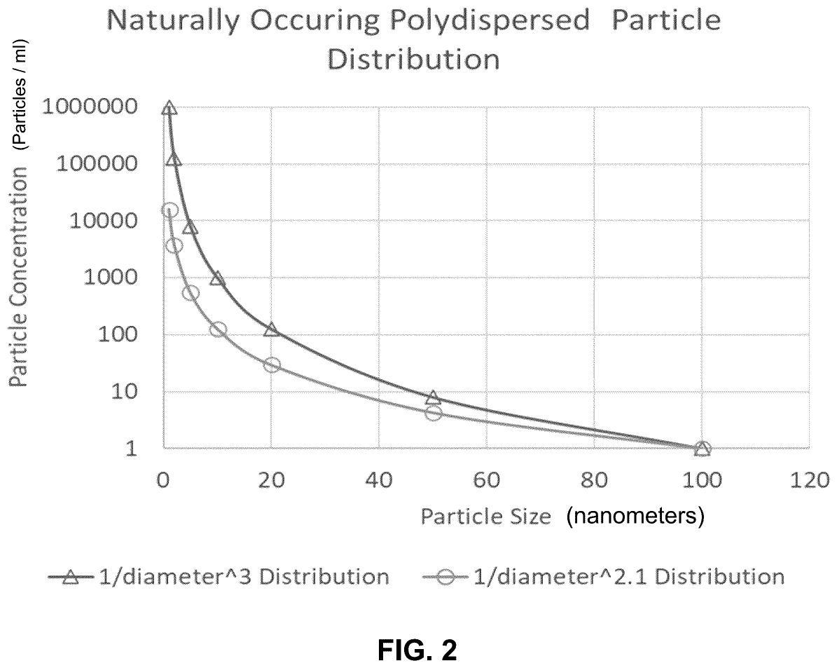

FIG. 3: Example of Fully and non-Fully Resolved Monodispersed Particle Challenges vs. Natural particle Populations.

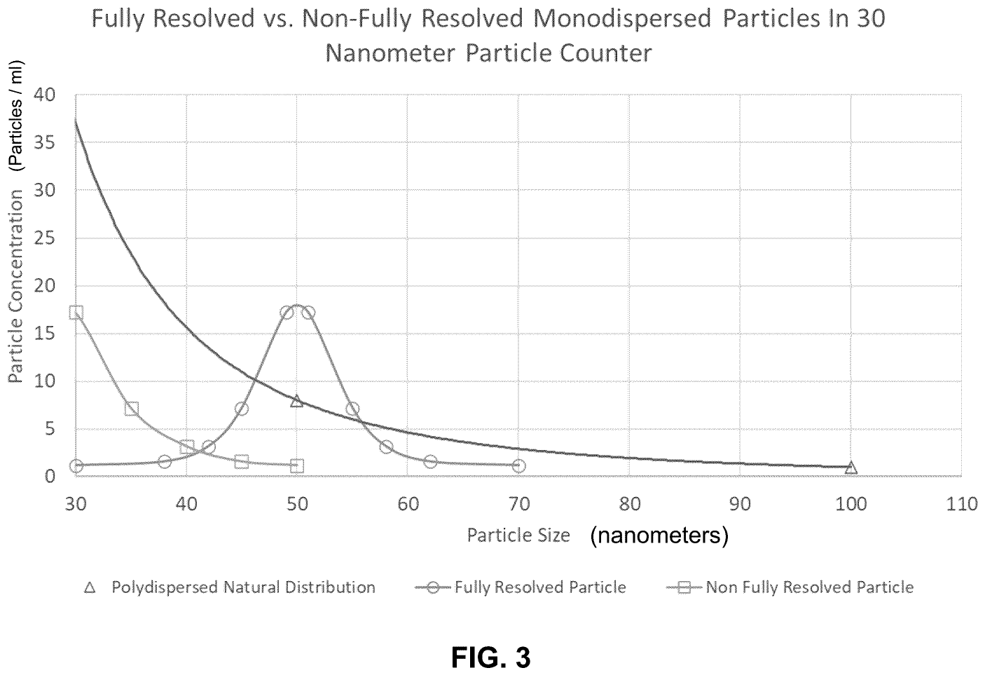

FIG. 4: Examples of fractional flow sample volume and laser irradiance variability.

FIG. 5: Examples of two like instruments with similar sensitivity and assumed design sample volume, but different true sample volumes on the same fluid and reporting particle counter per ml of fluid.

FIG. 6: Improved data quality and correlation following polydispersed challenge sample volume calibration and adjustment.

FIG. 7: one example of an improved calibration procedure in accordance with the present disclosure.

FIG. 8: a chart showing the differences between a monodispersed, natural polydispersed, and a pseudo monodispersed particle size distribution (ISO fine test dust). The chart shows particle size in microns on the x-axis and y-axis shows percentage of the total particles collected as a function of the particle size. For example, if a fluid is monitored for one minute and 1000 total particles of various sizes are detected, the number of particles measured at each size bin divided by 1000 and converted to percent would produce the percentage of the particles collected as a function of the particle size.

### Statements Regarding Chemical Compounds and Nomenclature

In general, the terms and phrases used herein have their art-recognized meaning, which can be found by reference to standard texts, journal references and contexts known to those skilled in the art. The following definitions are provided to clarify their specific use in the context of the invention.

“Particles” refers to small objects which are often regarded as contaminants. A particle can be any material created by the act of friction, for example when two surfaces come into mechanical contact and there is mechanical movement. Particles can be composed of aggregates of material, such as dust, dirt, smoke, ash, water, soot, metal, oxides, ceramics, minerals, or any combination of these or other materials or contaminants. “Particles” may also refer to biological particles, for example, viruses, spores and microorganisms including bacteria, fungi, archaea, protists, other single cell microorganisms. In some embodiments, for example, biological particles are characterized by a size dimension (e.g., effective diameter) ranging from 0.1-15 μm, optionally for some applications ranging from 0.5-5 μm. A particle may refer to a small object which absorbs, emits or scatters light and is thus detectable by an optical particle counter. As used herein, “particle” is intended to be exclusive of the individual atoms or molecules of a carrier fluid, for example water, air, process liquid chemicals, process gases, etc. In some embodiments, particles may be initially present on a surface, such as a tools surface in a microfabrication facility, liberated from the surface and subsequently analyzed in a fluid. Some systems and methods are capable of detecting particles comprising aggregates of material having a size dimension, such as effective diameter, greater than 20 nm, 30 nm, 50 nm, 100 nm, 500 nm, 1 μm or greater, or 10 μm or greater. Some embodiments of the present invention are capable of detecting particles having a size dimension, such as effective diameter, selected from that range of 10 nm to 150 μm, optionally for some applications 10 nm to −10 μm, optionally for some applications 10 nm to −1 μm, and optionally for some applications 10 nm to −0.5 μm.

The expression “detecting a particle” broadly refers to sensing, identifying the presence of, counting and/or characterizing a particle, such as characterizing a particle with respect to a size dimension, such as effective diameter. In some embodiments, detecting a particle refers to counting particles. In some embodiments, detecting a particle refers to characterizing and/or measuring a physical characteristic of a particle, such as effective diameter, cross sectional dimension, shape, size, aerodynamic size, or any combination of these. In some embodiments, detection a particle is carried out in a flowing fluid, such as gas having a volumetric flow rate selected over the range of 0.05 CFM to 10 CFM, optionally for some applications 0.1 CFM to 5 CFM and optionally for some applications 0.5 CFM to 2 CFM. In some embodiments, detection a particle is carried out in a flowing fluid, such as liquid having a volumetric flow rate selected over the range of 1 to 1000 mL/min.

“Optical Particle Counter” or “particle counter” are used interchangeably and refer to a particle detection system that uses optical detection to detect particles, typically by analyzing particles in a fluid flow. Optical particle counters include liquid particle counters and aerosol particle counters, for example, including systems capable of detecting individual single particles in a fluid flow. Optical particle counters provide a beam of electromagnetic radiation (e.g. a laser) into the analysis area, where the beam interacts with any particles and then detects the particles based on scatter, emitted or transmitted light from the flow cell. Detection may focus on electromagnetic radiation that is scattered, absorbed, obscured and/or emitted by the particle(s). Various detectors for optical particle counters are known in the art, including for example, single detection elements (e.g., photodiode, photomultiplier tube, etc.), detector arrays, cameras, various detector orientations, etc. Optical particle counter includes condensation particle counters, condensation nuclei counters, split beam differential systems and the like. When used in the context of a condensation particle counter, the particle counter portion refers to the detection system (e.g. source of electromagnetic radiation, optics, filters, optical collection, detector, processor, etc.). In an embodiment, for example, an optical particle counter comprises a source for generating a beam of electromagnetic radiation, beam steering and/or shaping optics for directing and focusing the beam into a region where a fluid sample is flowing, for example a liquid or gas flowing through a flow cell. A typical optical particle counter comprises of a photodetector, such as optical detector array in optical communication with said flow cell, and collection optics for collecting and imagining electromagnetic radiation which is scattered, transmitted by or emitted by particles which pass through the beam. Particle counters may further comprise electronics and/or processors components for readout, signal processing and analysis of electrical signals produced by the photodetector including current to voltage converters, pulse height analyzers, and signal filtering and amplification electronics. An optical particle counter may also comprise a fluid actuation systems, such as a pump, fan or blower, for generating a flow for transporting a fluid sample containing particles through the detection region of a flow cell, for example, for generating a flow characterized by a volumetric flow rate. Useful flow rates for samples comprising one or more gases include a flow rate selected over the range of 0.05 CFM to 10 CFM, optionally for some applications 0.1 CFM to 5 CFM and optionally for some applications 0.5 CFM to 2 CFM. Useful flow rates for samples comprising one or more liquids include a flow rate selected over the range of 0.01 to 1000 mL/min, optionally for some applications 0.01 to 100 mL/min.

The term “polydispersed” refers to a group of particles that is not monodispersed. Thus, a polydispersed group of particles may have a relatively wide distribution of particle size as compared to monodispersed particles. Further, a polydispersed

The term “polydispersed particle calibration sample” refers to a polydispersed group of particles to be used for a calibration procedure. A polydispersed particle calibration sample may be characterized by, for example, a lognormal distribution, Gaussian distribution, Lorentzian distribution, multimodal distribution and combinations thereof. A polydispersed particle calibration sample may be dispersed in a fluid, such as air or water. Useful polydispersed particle calibration samples include natural polydispersed particle calibration samples characterized by natural polydispersed particle distributions.

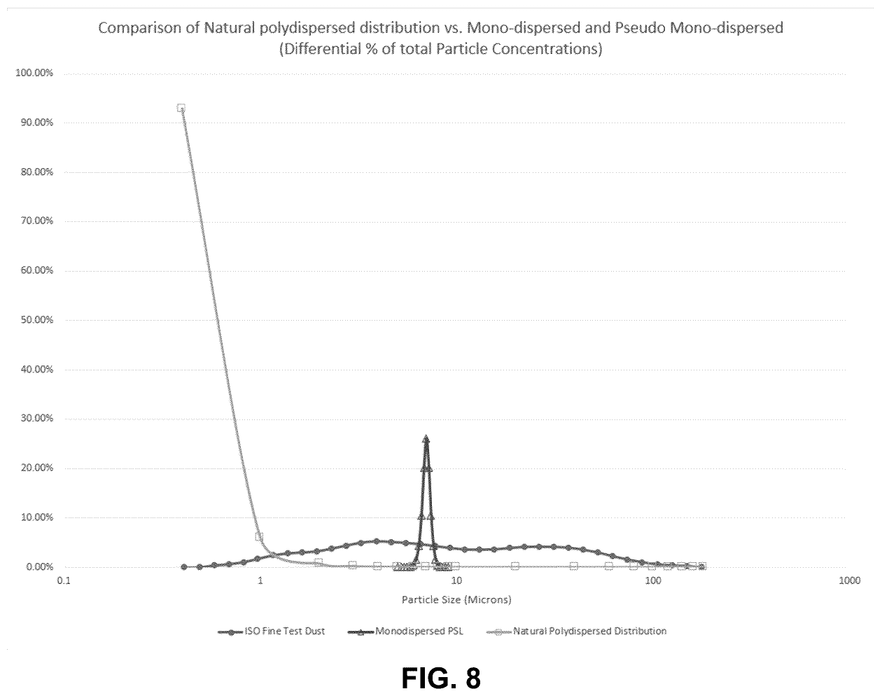

The term “natural polydispersed particle distribution” refers to a distribution wherein, above a minimum size threshold, particle concentration continuously increases as particle size decreases. Thus, in some embodiments, a polydispersed particle calibration sample has a polydispersed size distribution characterized by progressively more particles per unit volume of fluid at smaller sizes for particles having effective diameters greater than or equal to a particle size threshold. In some embodiments, the size threshold may be approximately 0.02 microns. In some embodiments, the size threshold may be approximately 0.1 microns. In some embodiments, the size threshold may be below the size detection threshold of a particle detection device under calibration. Thus, for particles that the unit under calibration is capable of detecting, the concentration of particles increases as the size of the particles decreases. “Natural” polydispersed particle distributions may be either naturally occurring or synthesized (i.e., pseudo natural polydispersed), so long as the distribution of particles have progressively more particles per unit volume of fluid at ever smaller sizes (above a certain size threshold, that may be below the detection limit of the device, as described above). A single natural polydispersed particle distribution may be comprised of a wide swath of different materials including microbes, dust, and various particles originating from the environment. One example of a natural polydispersed particle distribution is shown in FIG. 8.

The term “pseudo natural polydispersed” refers to a particle distribution that displays the same properties as a natural polydispersed distribution, namely, progressively more particles per unit volume of fluid at ever smaller sizes, but that originates synthetically rather than naturally.

The term “monodispersed” refers to groups of particles having a narrow distribution of particles. Monodispersed particle distributions generally have a single, distinct peak and relatively smaller standard deviation compared to polydispersed particle distributions. In a preferred embodiment, a monodispersed particle distribution may have a peak at a size that is at or above the size detection threshold of a particle detector under calibration. Thus, particularly useful monodispersed particle distributions may include monodispersed particle distributions that the particle detector under calibration is capable of fully resolving. One example of a monodispersed particle distribution that is fully resolved by a particle detector under calibration is shown in FIG. 8.

The term “monodispersed particle standard” refers to a monodispersed group of particles to be used for a calibration procedure. In one embodiment, the monodispersed particle standard is a quantified particle standard.

The term “quantified particle standard” refers to a monodispersed particle standard having preselected and well-defined statistical properties such as mean size and standard deviation. In some embodiments, essentially all of the particles of a quantified particle standard may be particles of the same material. For example, in one embodiment, a quantified particle standard may comprise polystyrene latex microspheres, such as those available from Sigma Aldrich.

The term “pseudo monodispersed” refers to a particle size distribution which lacks the single, distinct peak of a monodispersed distribution but also is not characterized by progressively more particles per unit volume of fluid at smaller sizes. Thus, a “pseudo monodispersed” is neither a natural polydispersed distribution nor a monodispersed distribution. One example of a pseudo monodispersed particle size distribution is the ISO fine test dust of FIG. 8.

The term “geometric standard deviation” (GSD or σ_{g}) GSD is defined as the ratio of the median diameter to the diameter at ±1 sd (σ) from the median diameter is another measure of the degree of dispersity of a particle sample. GSD may be particularly relevant to lognormal particle distributions and/or particle distributions which are well approximated by lognormal distributions. For example, in some embodiments, natural aerosol particle distributions may be well approximated as lognormal distributions. In some embodiments, a polydispersed particle calibration standard may have a GSD of greater than 1.25. In some embodiments, a monodispersed particle standard may have a GSD of less than or equal to 1.25. [Source: Aerosol Technology: Properties, Behavior, and Measurement of Airborne Particles,” by William C. Hinds].

Detecting and counting small particles (e.g., effective diameter less than 100 nm) in clean and ultraclean fluids in a manner that provides statistically significant data requires high signal-to-noise ratio (S/N). A high S/N ratio allows nanoparticles to be clearly detected above the noise floor. As used herein “statistically significant data” refers to detection of enough particles per unit time to be able to accurately assess contamination levels in the fluid. In some embodiments, high S/N does not relate to sizing accuracy directly. For example, in some optical particle counters the beam waist occupies a small fraction of the flow cell channel, and therefore, this approach monitors a subset of the total flow, such that it is possible for particles to pass through the edge of the beam where irradiance is less than the center. If a 50 nm particle passes through the outer edge of the beam, it may generate a signal similar to a 10 nm particle passing through the center of the beam. Therefore, it is possible for some optical particle counters to have high S/N and be able to detect, for example 20 nm particles, while not having very good sizing accuracy. In some of the present optical particle counters and methods a goal is to be able to count enough particles to provide a quantitative, statistically sound, assessment of contamination levels in ultrahigh purity fluids in the shortest period of time. For example, the current state of the art particle counter may require up to 40 minutes to count enough particles to provide a statistically appropriate concentration (acceptable relative standard deviation) measurement when monitoring a state of the art ultrapure water system. By improving and maintaining a high S/N through the present systems and methods, the time interval needed to measure this minimum statistically acceptable particle counts can be reduced by 10× or more. This provides value as it allows a user to identify deviations from process control limits more quickly.

The term “noise” refers to unwanted modifications of a signal (e.g. a signal of a photodetector) that interfere with the accuracy or precision of a particle detection system. Noise may derive from sources such as backscatter due to interfaces between materials in the optical path of the beam, backscatter due to contamination of optical components, and/or molecular scatter from the fluid in the particle interrogation region from reaching the laser. In some embodiments, noise due to backscatter may result in abnormal electronic signals whose amplitude can exceed a particle detection threshold, resulting in particle detection false counts.

The expression “high signal-to-noise ratio” refers to a signal-to-noise ratio of an optical particle detection system sufficient for accurate and sensitive detection of particles in a fluid flow, including particles characterized by a small physical dimension (e.g., an effective diameter of less than or equal to 200 nm, optionally for some embodiments less than or equal to 100 nm and optionally for some embodiments less than or equal to 50 nm). In an embodiment, “high signal-to-noise ratio” refers to a signal-to-noise ratio sufficiently high to sense particles characterized by a small physical dimension, such as particles having an effective diameter as low as 20 nm, optionally for some applications a diameter as low as 10 nm and optionally for some applications a diameter as low as 1 nm. In an embodiment, “high signal-to-noise ratio” refers to a signal-to-noise ratio sufficiently high to accurately detect and count particles with a false detection rate of less than or equal to 50 counts/L, for example, for detection of particles having an effective diameter selected over the range of 1-1000 nm. In an embodiment, “high signal-to-noise ratio” refers to a signal-to-noise ratio sufficiently high to provide a minimum statistically acceptable particle count in a timeframe at least a factor of 10× less than in a conventional optical particle counter. Systems and methods of the present disclosure may provide a high signal to noise ratio.

“Beam propagation axis” refers to an axis parallel to the direction of travel of a beam of electromagnetic radiation.

“Optical communication” refers to components which are arranged in a manner that allows light to transfer between the components.

“Optical axis” refers to a direction along which electromagnetic radiation propagates through a system.

“Light source” refers to a device or device component that is capable of delivering electromagnetic radiation to a sample. The term “light” is not limited to visible radiation, such as by a visible light beam, but is used in a broad sense to include any electromagnetic radiation also inclusive of visible radiation, ultraviolet radiation and/or infrared radiation. The optical source may be embodied as a laser or laser array, such as a diode laser, diode laser array, diode laser pumped solid state laser, LED, LED array, gas phase laser, laser oscillator, solid state laser, to name a few examples.

The term “electromagnetic radiation” and “light” are used synonymously in the present description and refer to waves of electric and magnetic fields. Electromagnetic radiation useful for the methods of the present invention include, but is not limited to ultraviolet light, visible light, infrared light, or any combination of these having wavelengths between about 100 nanometers to about 15 microns.

The term “particle interrogation zone” refers to a zone within a particle detection system where one or more particles interact with the incident beam and/or the pump beam to scatter light. In some embodiments, the particle interrogation zone may comprise a cuvette and/or a flow cell to constrain a particle-containing liquid flowing therethrough. In other embodiments, an unconstrained jet of particle-containing gas may flow through the particle interrogation zone. In still other embodiments, the particle interrogation zone may comprise a surface to be interrogated for particles.

The term “sample medium” refers to the matter or collection of matter comprising a sample to be measured by an optical particle analyzer. As an example, an optical particle analyzer may sample air from an environment. The air may or may not contain particles and it is thus one object of using the optical particle analyzer to determine whether or not the air in the environment has particles. In this example, the sample medium is the air of the environment.

The term “diagnostic parameter” refers to a measurable quantity or quality determined analytically through one or more outputs of the optical particle analyzer such as a detector signal waveform. The values of diagnostic parameters are determined at times between successful calibration events of the optical particle analyzer.

The term “diagnostic parameter associated with” refers to one or more values of the determined diagnostic parameters being representative of operational conditions and functioning of particle component(s) in the optical particle analyzer. For instance, values of a particular diagnostic parameter may vary according to a radiant power of scattered light incident upon on a photodiode-based detector of the optical particle analyzer. In this case, a determined value for such a diagnostic parameter that is less than an expected value (e.g., an out of specification result) may, for example and without limitation, indicate an operational problem with the source of electromagnetic radiation (e.g., a laser) whose beam is scattered and subsequently detected by the detector of the optical particle analyzer.

The term “operational condition” refers to a state of functioning of a particular component or set of components of the optical particle analyzer. Operational condition may be a strictly binary status where the component(s) are either functional or are non-functional. Operational condition may be a status on a continuum of functionality ranging from fully functional to fully non-functional. Such a continuum of functionality may include intermediate state(s) such as nearing an out of specification status and/or requiring some maintenance operation according to a predetermined schedule. As described in detail herein, values of diagnostic parameters determined using disclosed systems and methods may be associated with the operational condition of the respective component(s) of the optical particle analyzer for which the diagnostic parameters are associated.

The term “calibration status” refers to a particular functional state of the optical particle analyzer reflecting whether the optical particle analyzer is “in-calibration” or “out-of-calibration.” The calibration status of a particular optical particle analyzer is the status since the last successful calibration was performed and/or certified for that same particular particle analyzer. Calibration status may be a binary status where the particular optical particle analyzer is either in-calibration or is out-of-calibration. Calibration status may be a status on a continuum of statuses ranging from in-calibration to out-of-calibration. Such a continuum may include an intermediate status such as nearing an out-of-calibration status, nearing a time for a scheduled calibration, and/or approaching or exceeding one or more predetermined control alert limit(s). Depending on the application of interest, an analyzer may be defined as “calibrated” if it is within a user-defined tolerance, such as providing a parameter that is within 10%, within 5%, within 1% or within 0.1% of absolute calibrated.

The term “calibration parameter” takes on the same meaning as “diagnostic parameter,” with the exception that values of calibration parameters are determined during the same time for which successful calibration events are performed for the optical particle analyzer (e.g., determined between the start of the calibration event and the end of the calibration event).

The term “energization state” refers to a qualitative and/or quantitative measure of the stored electrical energy in a component of the optical particle analyzer.

The term “operably connected to” refers to two or more functionally-related components being coupled to one another for purposes of flow of electric current and/or flow of data signals. This coupling of the two or more components may be a wired connection and/or a wireless connection. The two or more components that are so coupled via the wired and/or wireless connection may be proximate one another (e.g., in the same room or in the same housing as the optical particle analyzer) or they may be separated by some distance in physical space (e.g., in a different building from the location of the optical particle analyzer).

The term “radiation” refers to energy in the form of waves and/or particles, such as energy undergoing emission or transmission through space or through a material medium. Preferably for some methods and applications, the term “radiation” refers to electromagnetic radiation. The term “electromagnetic radiation” and “light” are used synonymously in the present description and refer to waves, and/or photons, of electric and magnetic fields. As used herein, electromagnetic radiation includes, but is not limited to, radio waves, microwaves, infrared, visible light, ultraviolet, X-rays, and gamma rays. Electromagnetic radiation useful for the methods of the present invention includes, but is not limited to ultraviolet light, visible light, infrared light, or any combination of these having wavelengths between approximately 100 nanometers (nm) to approximately 15 microns (μm). The term “scattered radiation” refers to radiation resulting from scattering of radiation, such as radiation resulting from scattering of at least a portion of a beam (or, energy content thereof) of electromagnetic radiation. For example, an interaction between a beam of electromagnetic radiation, such as a laser beam, and matter, such as particles present in a medium through which the beam is being transmitted, may comprise scattering of at least a portion of the beam, or energy content thereof, of the electromagnetic radiation. For example, at least a fraction of photons of a beam of electromagnetic radiation may be scattered due interaction with matter or a non-uniformity in a medium. The terms “scattering” and “scatter” refer to a process by which radiation, such as electromagnetic radiation, is forced to deviate from a straight trajectory due to interaction with one or more non-uniformities in a medium through which the radiation is being emitted or transmitted. For example, scattering may refer to waves, or their quanta, photons, of electromagnetic radiation undergoing deviation(s) from one straight trajectory to at least a second trajectory due to interaction with matter or non-uniformity, such as one or more particles, in a medium, such as a fluid (e.g., gas, air, liquid, etc.), through which the waves, or photons, of electromagnetic radiation are being emitted or transmitted.

The terms “approximately” and “about” are used interchangeably and refer to a value that is within 20%, within 10%, within 5%, or, optionally, equal to a given reference value. For example, a wavelength that is about 100 nm is any wavelength that is within 20%, within 10%, within 5%, or preferably in some applications equivalent to 100 nm.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

Post manufacturing, particle counter use is predominantly on fluid (air, gas, liquid) media containing a variety of potential particle types. In the case of contamination monitoring devices, the particles tend to be a polydispersed distribution of naturally occurring contamination in a variety of morphologies and materials. The polydispersed contamination tends to follow well defined and characterized relationships of particle population vs. size, with far more individual particles of smaller size than those of larger size. These relationships have been defined as a means of characterizing cleanroom and clean manufacturing environments for decades as the ISO and FED Standard 209 classification systems. In air/gas samples the widely accepted distributions follow a 1/d^{2.1} power relationship and in liquids, the relationship tends to be steeper and more aligned with a 1/d³ power distribution, but can vary based on physical and filtration systems efficiencies.

In these distributions, the concentration of particles at the minimum detectable size can be 8-20× the concentration of the smallest size particles the unit is capable of fully resolving.

In addition, the sensitivity and sample volume measurement accuracy can be impacted by variances in the fractional flow being interrogated by the laser beam or irradiance variability through the beam from one unit to the next.

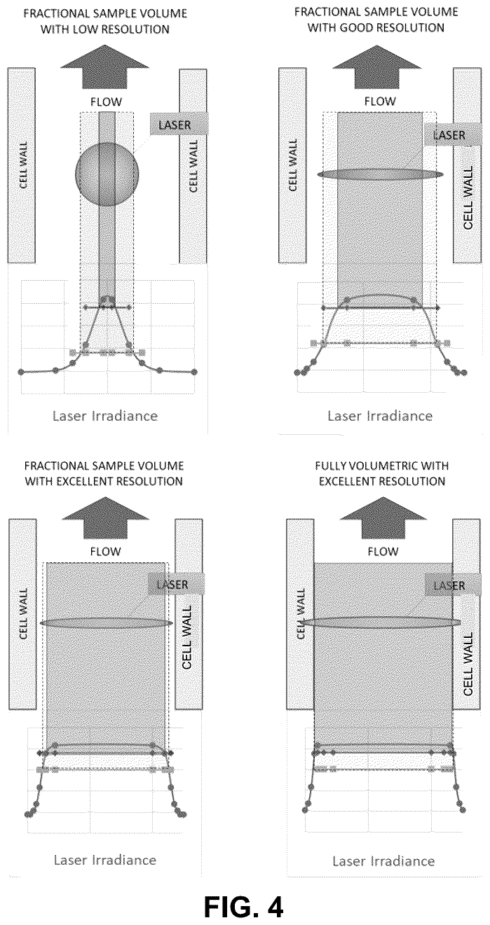

FIG. 4 shows several examples of partial laser interrogation regions and the variances in sample volume dependent upon particle size. The red line (diamond marker) signifies the irradiance needed to see pulses of light from particles equal in size to the designated first channel size of the instrument. The gray line (square marker) identifies the irradiance needed to see pulses of light from the first fully resolved monodispersed particle challenge available. The resultant shaded regions illustrate the variance in fractional sample volume ratios with 100% of the flow contained within the sample cell walls.

TABLE 1
Illustration of sample volume growth challenges
represented by 4 different instrument designs.

| | | | Sample Volume |
|---|---|---|---|
| | % of flow | % of flow | Growth 1^{st} |
| | measured | fully | channel to fully |
| | 1^{st} | resolved | resolved |
| | channel | channel | channel |
| Fractional Sample Volume | 11% | 38% | 232% |
| with Low Resolution | | | |
| Fractional Sample Volume | 60% | 80% | 34% |
| with Good Resolution | | | |
| Fractional Sample Volume | 85% | 91% | 7% |
| with Excellent Resolution | | | |
| Fully Vollumetric with | 100% | 100% | 0% |
| Excellent Resolution | | | |

As can be seen, some designs generate significant sample volume differences. This sample volume growth as well those imparted by other system components like the detector system, etc., impart inconsistent performance relationships between particles of different sizes. Variability exists not only in the design itself, but between each instance of the instrument as-built. This fact accentuates the potential error associated with reliance on universally applied or assumed sample volumes for any given instrument or those determined via monodispersed challenge determined sample volumes. The variance coupled with the power distribution relationship of naturally occurring contamination in fluid challenges creates a significant opportunity for error and tends to result in substantial unit-to-unit performance variability in terms of reported particles per unit volume. This variability is accentuated in samples with steeper particle distributions>1/diameter².

Accordingly, the improved calibration methods disclosed herein have been developed to address the issues described above.

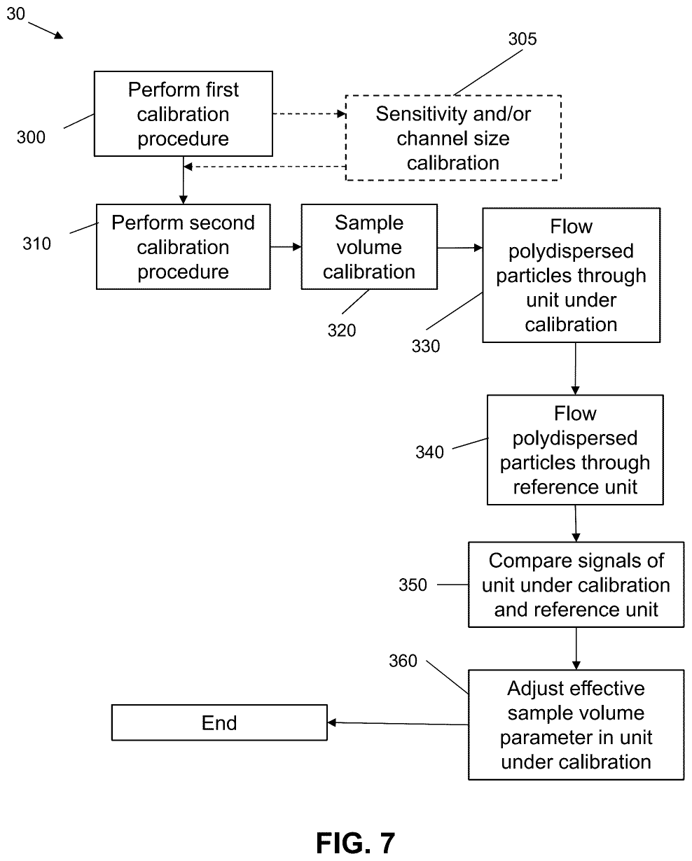

Turning now to FIG. 7, one example of an improved method for calibration of optical particle counters is shown. The exemplary method 30 includes the step of performing a first calibration procedure 300. The first calibration procedure 300 may include sensitivity and/or channel size calibration 305.

The sensitivity calibration is performed to set the detection threshold voltage of the smallest size channel of the particle counter. In one embodiment, the particle size standard corresponding to the size of the smallest channel is sampled in parallel with a reference instrument and the detection threshold voltage is adjusted until the unit under test matches the counting rate of the reference unit.

The channel size calibration may be performed for the size channels that are larger than the first (smallest) size channel. In one embodiment, size calibration particles which are the intended particle channel size are sampled and the detection voltage threshold is adjusted until 50% of the particle detections are above the threshold voltage and 50% are below the threshold voltage.

Once the first calibration procedure is complete, a second calibration procedure 310 is employed. The second calibration procedure 310 includes a sample volume calibration 320.

The sample volume calibration 320 may include flowing 330 polydispersed particles through the unit under calibration. The polydispersed particles may have a natural distribution in that for particles above a threshold, the concentration of particles of a given size in the sample is inversely proportional to particle size. Furthermore the threshold may be below the lower detection limit of the instrument. Thus, practically speaking for the purposes of calibration, the concentration of particles in the polydispersed particle sample increases as particle size decreases.

The same polydispersed particle sample may then be flowed 340 through a pre-calibrated reference instrument. Then the signals from the two units may be compared 350. Finally, an effective sample volume parameter may be adjusted 360 and stored in the instrument under calibration. In this way, the variance in effective volumetric sampling rates from instrument to instrument can be adjusted for.

Thus, after a unit under test (UUT) has gone through sensitivity and channel size calibration, verification and refinement of sample volume can be made through comparison to a reference instrument and challenge from a more representative polydispersed particle challenge simulating the distribution of contamination closer to that found in user environments.

The result of this testing indicates the realized sample volume of the UUT and can be programmed into the unit to properly capture the volume of fluid analyzer per unit of time.

One example of the formula used for such a comparison includes the following:

$$Ref\_CE \_Ratio = ( Reference\_Nominal \_CountingEfficiency /$$

$$Reference\_Actual \_CountingEfficiency )$$

$$Ref\_CE \_Ratio = ( Reference\_Nominal \_CountingEfficiency /$$

$$Reference\_Actual \_CountingEfficiency )$$

$$Ref\_SV \_Ratio = ( Reference\_Nominal \_SampleVolume /$$

$$Reference\_Actual \_SampleVolume )$$

$$Ref\_Flowrate \_Ratio =$$

$$( Reference\_Nominal \_Flowrate / Reference\_Actual \_Flowrate )$$

$$Expected\_Counts = ( ( ( Reference\_Counts * Ref\_Flowrate \_Ratio ) *$$

$$Ref\_SV \_Ratio ) * Ref\_CE \_Ratio )$$

The following calculation may then be performed with the UUT measured cumulative raw counts to determine sample volume:

$$UUT SV = ( ( ( UUT\_Counts / Expected\_Counts ) * Nominal\_Sample \_Volume ) * ( UUT\_Nominal \_Flowrate / UUT\_actual \_Flowrate ) )$$

The UUT SV may be numerically entered into the particle counter's memory. Then, to output normalized particle counts, the particle counter divides the number of particles measured per min by UUT SV to create a normalized data point in units of particles/unit volume.

Other values can be considered in a calibration adjustment including refractive index of fluid, particles or even a mechanism where sample volume for each size channel could be different to account for variable counting efficiencies and or volume by size.

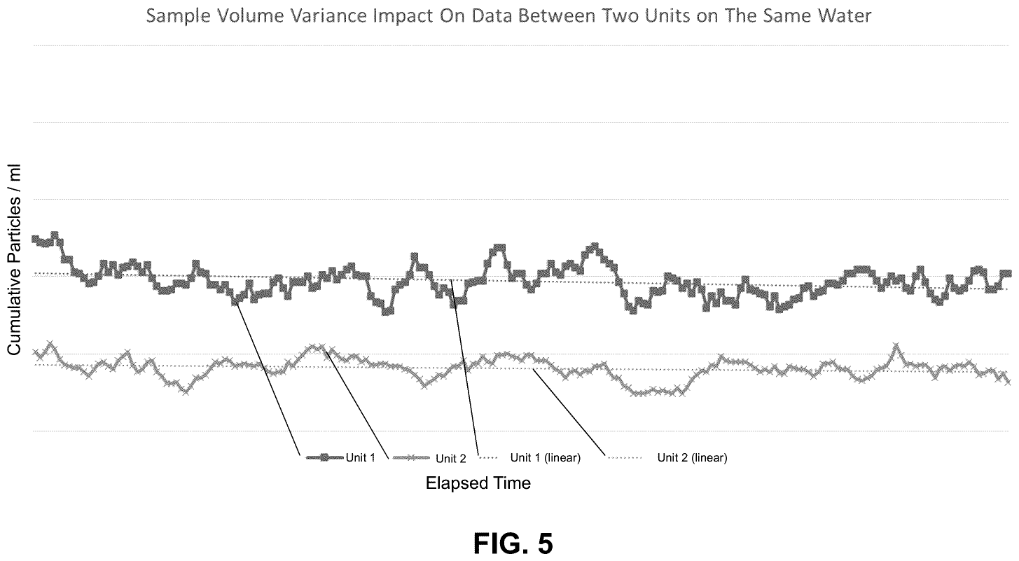

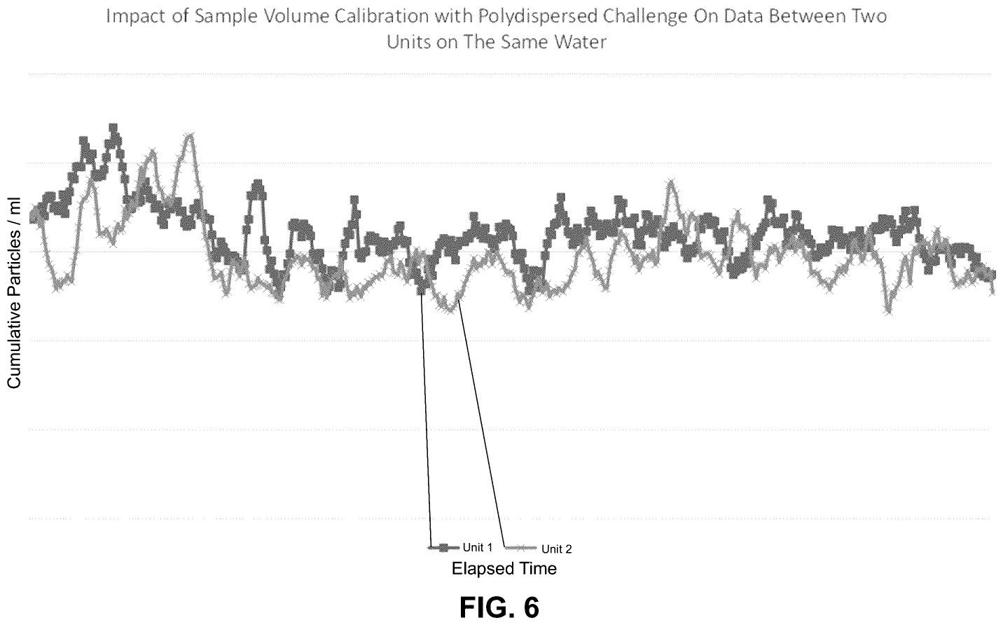

FIG. 5 shows one example of the variance between to instruments before the disclosed calibration method has been performed. As can be seen, there is a persistent difference between the two instruments in terms of measured concentration of particles, despite both instruments measuring the same samples. FIG. 6 shows the results after the disclosed calibration procedure has been performed. As can be seen, the persistent difference in the output of the instruments has been essentially eliminated.

### Statements Regarding Incorporation by Reference and Variations

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Every device, system, formulation, combination of components, or method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method of calibrating a first optical particle counter, the method comprising:
performing a first calibration procedure on a first optical particle counter, the first optical particle counter being a device under calibration, the first calibration procedure comprising:
sensitivity calibration of the first optical particle counter; and/or
channel size calibration of the first optical particle counter using a monodispersed particle standard and/or a pseudo monodispersed particle standard;
performing a second calibration procedure on the first optical particle counter, the second calibration procedure comprising:
sample volume calibration of the first optical particle counter, the sample volume calibration comprising:
flowing a polydispersed particle calibration sample dispersed in a fluid through the first optical particle counter to produce a first signal output;
flowing the polydispersed particle calibration sample dispersed in the fluid through a second optical particle counter to produce a reference signal output, the second optical particle counter being a reference device;
comparing the first signal output with the reference signal output; and
adjusting, in response to the comparing, an effective sample volume parameter stored in a computer readable memory of the first optical particle counter.

2. The method of claim 1, wherein the second calibration procedure utilizes a natural polydispersed particle calibration sample.

3. The method of claim 2, wherein the second calibration procedure standardizes a sensitivity, counting efficiency and/or sample volume of the first particle counter relative to the reference optical particle counter.

4. The method of claim 1, wherein the signal output of the first optical particle counter has a plurality of signal channels, a first signal channel being correlated to particles corresponding to a lower size detection limit of the first optical particle counter, and wherein the polydispersed particle calibration sample has a higher concentration of particles correlated to the first signal channel than a concentration of particles correlated to other channels of the plurality of signal channels.

5. The method of claim 1, wherein the first calibration procedure comprises flowing the monodispersed particle standard and/or the pseudo monodispersed particle standard dispersed in a fluid through the first optical particle counter.

6. The method of claim 5, wherein the monodispersed particle standard and/or the pseudo monodispersed particle standard is a quantified particle standard.

7. The method of claim 5, wherein the first calibration procedure comprises:
flowing the monodispersed particle standard and/or the pseudo monodispersed particle standard through the second optical particle counter or a supplemental reference optical particle counter; and
comparing a signal output from the first optical particle counter with a signal output from the second optical particle counter or the supplemental reference optical particle counter.

8. The method of claim 5, wherein an average size of particles in the monodispersed particle standard and/or the pseudo monodispersed particle standard corresponds to a signal channel of the first optical particle counter that is not the first channel.

9. The method of claim 1, wherein the first optical particle counter comprises an optical light source providing a focused beam light on a particle interrogation region, and one or more photodetectors to detect scattered light; and wherein the effective sample volume parameter corresponds to a volume of fluid per unit of time exposed to focused beam conditions and/or detection conditions to be analyzed by the first optical particle counter for the measurement of particles.

10. The method of claim 9, wherein the effective sample volume is from 0.01%-90% of the volume per unit time of fluid passed through the first optical particle counter.

11. The method of claim 1, wherein the effective sample volume parameter is a first effective sample volume parameter, the first effective sample volume parameter corresponding to the first signal channel, the method further comprising:
determining a second effective sample volume parameter, the second effective sample volume parameter corresponding to a second signal channel of the plurality of signal channels.

12. The method of claim 1, comprising calculating, via the effective sample volume parameter, an effective sampling volume of fluid analyzed per unit time of the first optical particle counter.

13. The method of claim 1, comprising calculating, via the effective sample volume parameter, a number of particles detected per volume of fluid analyzed per unit time of the first optical particle counter.

14. The method of claim 1, wherein the second optical particle counter has a sensitivity equal to or greater than the first optical particle counter.

15. The method of claim 1, wherein the polydispersed particle calibration sample is a natural particle sample or an at least partially artificially generated particle sample simulating a natural particle sample.

16. The method of claim 1, wherein the polydispersed particle calibration sample is characterized by a natural or pseudo natural polydispersed size distribution.

17. The method of claim 1, wherein the polydispersed particle calibration sample has a polydispersed size distribution characterized by progressively more particles per unit volume of fluid at smaller sizes for particles having effective diameters greater than or equal to a particle size threshold.

18. The method of claim 1, wherein the polydispersed particle calibration sample has a polydispersed size distribution characterized by particle concentrations inversely proportional to particle effective diameters for particles having effective diameters greater than or equal to a particle size threshold.

19. The method of claim 17, wherein the particle size threshold is 0.1 nm.

20. The method of claim 1, wherein the polydispersed particle calibration sample has a polydispersed particle size distribution at least partially characterized by a lognormal distribution, Gaussian distribution, Lorentzian distribution, multimodal distribution or any combination of these.

21. The method of claim 1, wherein the polydispersed particle calibration sample is characterized by a polydispersed particle size distribution that corresponds to the natural particle size distribution of a target class of analyte particles.

22. The method of claim 1, wherein the polydispersed particle calibration sample has an artificial polydispersed particle size distribution that mimics a natural distribution.

23. The method of claim 1, wherein the concentration of particles in the polydispersed particle calibration sample having effective diameters greater than or equal to a particle size threshold is proportional to 1/d^{x}, where x is selected from the range of 1.4 to 5.

24. The method of claim 23, wherein x is 2.1, 3.0, 4.0, or 5.0.

25. The method of claim 23, wherein x is 2.1 or greater, 3.0 or greater, or 4.0 or greater.

26. The method of claim 1, wherein the monodispersed particle standard and/or the pseudo monodispersed particle standard has a particle size distribution characterized by an average particle size selected from the range of 0.002 to 100 microns and a standard deviation selected from the range of 0.1 to 50%.

27. The method of claim 1, wherein the polydispersed particle calibration sample comprises a plurality of particles having a polydispersed size distribution, wherein an average effective particle diameter of the plurality of particles is smaller than a lower detection limit of the first optical particle counter.

28. The method of claim 1, wherein the first optical particle counter has a particle size detection limit equal to or greater than 50 nm, 40 nm, 30 nm, 20 nm, 10 nm, 5 nm or 2 nm.

29. The method of claim 1, wherein the first optical particle counter has an effective sampling volume of fluid analyzed per unit time selected from the range of 0.01 ml/min to 100 ml/min.

30. The method of claim 1, wherein the particle standard of the first calibration procedure is a monodispersed particle standard having a monodispersed particle distribution.

31. The method of claim 30, wherein the first optical particle counter has a lower particle size detection threshold, and wherein the particle standard of the first calibration procedure has a peak at a particle size that is at or above the lower particle size detection threshold.

32. The method of claim 1, wherein the particle standard of the first calibration procedure is a pseudo monodispersed particle standard having a pseudo monodispersed particle distribution.

33. The method of claim 1, wherein the polydispersed particle calibration sample of the second calibration procedure is a natural polydispersed particle sample.

34. The method of claim 1, wherein the polydispersed particle calibration sample of the second calibration procedure is a pseudo natural polydispersed particle sample.
